(19) United States
(12) Patent Application Publication
(10) Pub. No.: US 2003/0196117 A1
(43) Pub. Date: Oct. 16, 2003

(54) Home server access system including server and access control method

(75) Inventors: Akihisa Kenmochi, Tokyo (JP); Masaru Minakawa, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/410,302

(22) Filed: Apr. 10, 2003

(30) Foreign Application Priority Data
Apr. 12, 2002 (JP) 2002-110090

(51) Int. Cl. G06F 11/30

(52) U.S. Cl. 713/201

(57) ABSTRACT

A home server access system and an access control method are disclosed wherein a home server can be accessed even if a service wherein a fixed global IP is applied, a DNS service, a dynamic DNS service and so forth cannot be utilized. A plurality of terminals of different users including an authorized user determined in advance are connected to a home server. The home server includes an IP address information acquisition section for acquiring an IP address of the server itself, an authorized user information storage section for storing information which specifies a terminal of the authorized user, and an access destination notification section for issuing a notification of the IP address acquired by the IP address information acquisition section or access destination information of the URL form produced by adding directory information in the home server to the IP address. The IP address of the home server is acquired in accordance with an instruction of the user or an instruction signaled from a timer provided in the home server, and a notification of access destination information is issued to the authorized user.

### BACKGROUND OF THE INVENTION

1. Field of the Invention

The present invention relates to a server and a home server access system including a server as well as an access control method.

2. Description of the Related Art

In order to make a home server accessible through the Internet, it is necessary to use a fixed global IP service or DNS service or a dynamic DNS service. ADNS service and a database on the Internet are disclosed, for example, in Japanese Patent Laid-Open No. 2002-26971, No. 2000-112851, or No. 1999-225152.

Japanese Patent Laid-Open No. 2002-26971 discloses a method where in user IDs and corresponding IP addresses are stored in an identification database and domain names and corresponding IP addresses are stored in a DNS database, and, in response to dialup connection from a user, the identification database or the DNS database is used to allocate a fixed global IP address or a fixed domain name to the user. Where the method described is used, a user by itself can install and manage a server based on the domain name of the user itself, and the server can receive an access to the server through the Internet based on its IP address or the domain name.

Meanwhile, Japanese Patent Laid-Open No. 2000-112851 discloses a method wherein, in a LAN which includes a DHCP server for adaptively allocating an IP address to a terminal and a DNS server for resolving host names to IP addresses, MAC addresses and hostnames are fixedly coordinated with each other and the coordination data is possessed commonly by the DHCP server and the DNS server, and the DHCP server issues a notification of a coordination between an allocated IP address of a terminal and a MAC address of the terminal to the DNS server and the DNS server resolves a hostname to the IP address of the terminal based on the notification information. Where the method described is used, accessing between terminals based on a hostname using the DNS is allowed while dynamic allocation of an IP address by the DHCP is performed.

If the services are used, then it is possible to acquire an IP address of a home server and access the home server through the Internet. However, where a user cannot utilize the services or does not want to use the services from a reason on the security, although it is necessary for the user to know the IP address of the home server using some measures, no such measures have been provided conventionally.

### SUMMARY OF THE INVENTION

It is an object of the present invention to provide a server which can be accessed through the Internet even if a user of the server cannot utilize a service wherein a fixed global IP is applied, a DNS service, a dynamic DNS service and so forth or does not want to utilize them from a consideration on the security.

It is another object of the present invention to provide a home server access system and an access control method wherein a home server can be accessed exclusively by authorized users through the Internet even if a home server administrator cannot utilize a service wherein a fixed global IP is applied, a DNS service, a dynamic DNS service and so forth or does not want to utilize them from a consideration on the security.

In order to attain the objects described above, according to an aspect of the present invention, there is provided a server, comprising address information acquisition means for acquiring an address of the server itself on a network, authorized user information storage means for storing information which specifies a contact address of a user authorized to access the server in advance, and access destination notification means for issuing a notification of access destination information produced based on the address acquired by the address information acquisition means to the contact address of the authorized user.

According to another aspect of the present invention, there is provided a server, comprising address information request issuance means for issuing an address information request to an address information providing server on the Internet, address information analysis means for analyzing the address information received from the address information providing server to acquire an address of the server itself, authorized user information storage means for storing information which specifies a contact address of a user authorized to access the server in advance, and access destination notification means for issuing a notification of access destination information produced based on the address acquired by the address information analysis means to the contact address of the authorized user.

Each of the servers may be configured such that it further comprises address notification control means for signaling an address information acquiring instruction to the address information acquisition means or an address information request issuing instruction to the address information request issuance means at time determined in advance or at intervals of time determined in advance, and the address is automatically acquired by the address notification control means and a notification of the address is issued to the contact address of the authorized user. In this instance, each of the servers may be further configured such that it further comprises update monitoring means for storing the address and comparing the stored address and a newly acquired address with each other, and, only when it is discriminated by the update monitoring means that the address is updated, a notification of the address is issued to the contact address of the authorized user.

Each of the servers may be configured such that it further comprises instruction means operable by a home server administrator and the authorized user for signaling an address information acquiring instruction to the address information acquisition means or an address information request issuing instruction to the address information request issuance means, and, if the administrator or user issues an instruction using the instruction means, then the address is acquired.

Each of the servers may be configured such that it further comprises mail reception means for receiving an address acquisition instruction mail through the network and mail analysis means for analyzing the received address acquisition instruction mail, and that the address information acquiring instruction or the address information request issuing instruction information is searched from within the address acquisition instruction mail, and if the information is included, then the address is acquired. In this instance, the mail analysis means may include a function for searching authentication information of the authorized user from within the address acquisition instruction mail, and, if the authentication information is included, then the searching for the address information acquiring instruction or the address information request issuing instruction information may be executed. Alternatively, the server may be configured such that it further comprises means for producing a request form for the address acquisition instruction mail and means for transmitting the request form to a terminal of the authorized user, and that, if the address acquisition instruction mail is received as a reply from the terminal of the authorized user, then acquisition of the address is executed.

Preferably, the access destination information is the address or information of the URL format produced by adding directory information in the server to the address.

Authentication information may be added to the access destination information, and, when the authorized user accesses the server, user authentication may be performed.

According to a further aspect of the present invention, there is provided a home server access system, comprising a home server, and a plurality of terminals of different users connected to the home server through a network, the home server including address information acquisition means for acquiring an address of the server itself on the network, authorized user information storage means for storing information which specifies a contact address of a user authorized to access the server in advance, and access destination notification means for issuing a notification of access destination information produced based on the address acquired by the address information acquisition means to the contact address of the authorized user.

According to a still further aspect of the present invention, there is provided a home server access system, comprising a home server, and a plurality of terminals of different users connected to the home server through a network, the home server including address information request issuance means for issuing an address information request to an address information providing server on the Internet, address information analysis means for analyzing the address information received from the address information providing server to acquire an address, authorized user information storage means for storing information which specifies a contact address of a user authorized to access the server in advance, and access destination notification means for issuing a notification of access destination information produced based on the address acquired by the address information analysis means to the contact address of the authorized user.

According to a yet further aspect of the present invention, there is provided an access control method executed by a server, comprising the steps of acquiring an address of the server itself on a network, storing information which specifies a contact address of a user authorized to access the server in advance, and issuing a notification of access destination information produced based on the acquired address to the contact address of the authorized user.

According to a yet further aspect of the present invention, there is provided an access control method executed by a server, comprising the steps of issuing an address information request to an address information providing server on the Internet, analyzing the address information received from the address information providing server to acquire an address, storing information which specifies a contact address of a user authorized to access the server in advance, and issuing a notification of access destination information produced based on the acquired address to the contact address of the authorized user.

In both of the access control methods, authentication information maybe added to the access destination information, and, when the authorized user accesses the server, user authentication may be performed. In this instance, authentication information which can designate whether or not each of folders or files can be accessed may be used as the authentication information.

In any of the servers, home server access systems and access control methods above, the home server acquires the address making use of an address information providing server on the Internet or the like when an address acquisition instruction is issued or periodically by means of a timer function, receives the acquired address and authorized user notification destination information and transmits the access destination information to the authorized user. Consequently, even if the home server administrator cannot utilize a fixed global IP address or a dynamic DNS service or does not want to utilize them from a reason on the security, accessing to the home server is permitted only to the authorized user.

More particularly, the servers, home server access systems and access control methods exhibit the following advantages.

First, even where the home server cannot utilize a fixed global IP address, only the authorized user who is permitted to access the home server in advance can access the home server.

The reason is that, since the home server receives an IP address thereof acquired by the IP address information acquisition section and authorized user notification destination information and issues a notification of the access destination information to the authorized user set in advance, the authorized user can access the home server using a common HTTP request.

Second, acquisition of the IP address can be performed suitably, and such a problem that the home server cannot be found readily upon accessing in such an Internet connection that a global IP address provided is sometimes changed dynamically as in an ADSL connection can be overcome.

The reason is that such a countermeasure is taken that an IP address notification control timer is provided and outputs an IP address information acquisition instruction or an IP address information request issuance instruction at predetermined times of day or at predetermined intervals of time to acquire the IP address, that a user interface is provided so that the IP address can be acquired when the home server administrator wants it or that a requesting notification for access destination information is issued using a mail from the user.

Third, the security of the system can be promoted.

The reason is that such a countermeasure is taken that a mail collation analysis section is provided and monitors to discriminate whether or not a mail of a request for access destination information has been originated from the authorized user and then transmits the access destination information only when the mail is a request from the authorized user or that an access destination information requesting form preparation section and a requesting form transmission section are provided and transmit a requesting form only to the authorized user and then transmits the access destination information only in response to a reply from the authorized user.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1 is a block diagram showing a configuration of a home server access system to which the present invention is applied;

FIG. 2 is a block diagram illustrating accessing of an authorized user to a home server in the home server access system of FIG. 1;

FIG. 3 is a block diagram showing a configuration of another home server access system to which the present invention is applied;

FIGS. 4(a) and 4(b) are block diagrams showing a first modification to the home server access systems of FIGS. 1 and 3, respectively;

FIGS. 5(a) and 5(b) are block diagrams showing a second modification to the home server access systems of FIGS. 1 and 3, respectively;

FIG. 6 is a block diagram showing a third modification to the home server access systems of FIGS. 1 and 3;

FIG. 7 is a block diagram showing a fourth modification to the home server access systems of FIGS. 1 and 3;

FIG. 8 is a block diagram showing a modification to the modified home server access system of FIG. 7;

FIG. 9 is a block diagram showing another modification to the home server access system of FIG. 7;

FIG. 10 is a block diagram showing a modification to the modified home server access system of FIG. 9;

FIG. 11 is a block diagram showing a further modification to the modified home server access system of FIG. 7;

FIG. 12 is a block diagram showing a modification to the modified home server access system of FIG. 11; and

FIG. 13 is a block diagram illustrating authentication performed when an authorized user accesses a home server.

### DESCRIPTION OF THE PREFERRED EMBODIMENTS

In a preferred form of a home server access system according to the present invention, a plurality of terminals of different users including a specific user (authorized user) determined in advance by a home server manager are connected to a home server to form a network, and the home server includes an IP address information acquisition section for acquiring an IP address of the server itself, an authorized user information storage section for storing information which specifies a terminal of the authorized user, and an access destination notification section for issuing a notification of the IP address acquired by the IP address information acquisition section or access destination information of the URL form produced by adding directory information in the home server to the IP address. The IP address of the home server is acquired in accordance with an instruction of a user, an instruction signaled from a timer provided in the home server or an instruction based on an electronic mail of a predetermined form, and a notification of access destination information is issued to the authorized user.

[Embodiment 1]

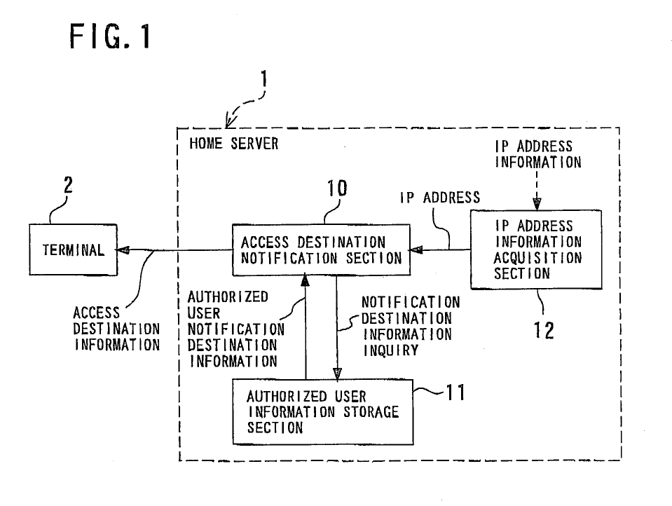

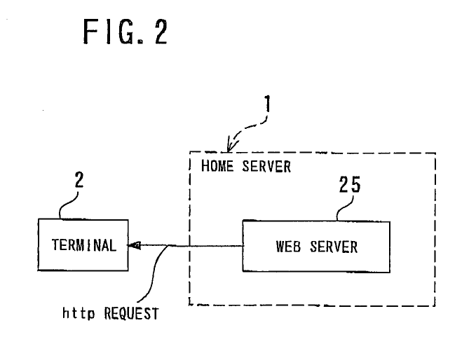

First, a server and a home server access system as well as an access control method to which the present invention is applied are described with reference to FIGS. 1 and 2. FIG. 1 shows a configuration of the home server access system together with an outputting procedure of access destination information by the home server access system, and FIG. 2 illustrates accessing of an authorized user to a home server of the home server access system.

Referring first to FIG. 1, the home server access system shown includes a home server 1 which outputs access destination information, a terminal 2 of a specific user (hereinafter referred to as authorized user) authorized to access the home server 1 in advance by a home server manager, and terminals of other users (not shown), which are connected to each other to form a network. The home server 1 includes an IP address information acquisition section 12 for acquiring an address of the home server Ion the network (as the address, an IP address is used as an example in the following description), an access destination notification section 10 for issuing a notification of access destination information to the authorized user, and an authorized user information storage section 11 for storing registration information of the authorized user.

In the following, operation of the home server access system having the configuration described above is described.

The IP address information acquisition section 12 has a function for acquiring an IP address of the home server 1 and outputting the IP address.

For example, where the home server 1 is a computer which incorporates the Windows (registered trademark), which is an operating system of Microsoft, and a modem is directly connected to the home server 1 by an interface such as a universal serial bus (USB) included in the personal computer and besides the home server 1 is connected to an Internet service provider, if the IP address information acquisition section 12 calls a command (for example, ipconfig.exe) provided in the “Windows” to receive an output of the command, then the IP address information acquisition section 12 can acquire the IP address of the home server 1 On the other hand, where the home server 1 is a computer which incorporates the Linux operating system, since an IP address of a network adapter is stored as a file, contents of the file may be read out.

Further, when the IP address outputted from the IP address information acquisition section 12 is received, the access destination notification section 10 transmits an inquiry for notification destination information to the authorized user information storage section 11 which stores information of a notification destination (hereinafter referred to as authorized user) registered in advance to acquire authorized user notification destination information from the authorized user information storage section 11. Thereafter, the access destination notification section 10 transmits the access destination information to the authorized user using the acquired IP address and authorized user notification destination information.

Here, the access destination information is an IP address or information of the URL form which includes directory information in a home server added to an IP address such as, for example, http://*.*.*.*/ or http://*.*.*.*/home/ (* represents a numeral ranging from 0 to 255). Further, as measures for transmitting access destination information to the authorized user, for example, an electronic mail is used. In this instance, the authorized user information storage section 11 stores, for example, a mail address as notification destination information of the authorized user. It is to be noted that contents of the authorized user notification destination information are inputted in advance, for example, by the home server manager.

If the authorized user having acquired the access destination information using the method described above intends to access the home server 1 from the terminal 2, then the authorized user may access a web server 25 using a common HTTP request as seen in FIG. 2.

In this manner, with the server and the home server access system as well as the access control method of the present embodiment, the IP address information acquisition section 12 can acquire and output the IP address of the home server 1, and the authorized user information storage section 11 can store information of a notification destination registered in advance and, when an inquiry is received, output authorized user notification destination information. Further, the access destination notification section 10 can receive the IP address outputted from the IP address information acquisition section 12 and the authorized user notification destination information obtained through the inquiry to the authorized user information storage section 11 and output the access destination information to the terminal 2 of the authorized user. Consequently, the authorized user who has acquired the access destination information can access the home server 1 using a common HTTP request.

Thus, even if the home server 1 cannot utilize a fixed global IP address or a dynamic DNS service, an authorized user who has been permitted to access in advance can access the home server 1. Further, also where it is desired to avoid accessing or attack from many and unspecified persons in the world, since a notification of accessing destination information can be issued only to the authorized user to whom accessing is permitted, the present invention is effective also in respect of the security.

[Embodiment 2]

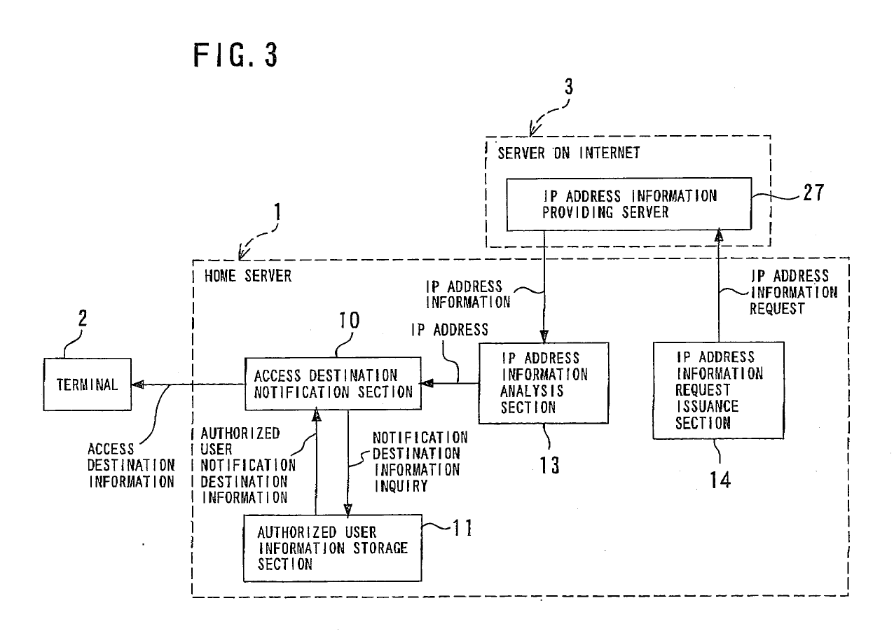

Now, another server and home server access system as well as access control method to which the present invention is applied is described with reference to FIG. 3 which shows a configuration of the home server access system.

In the present home server access system, a home server 1 includes an IP address information request issuance section 14 for signaling an IP address information request for the home server 1 to a server 3 on the Internet, an IP address information analysis section 13 for acquiring and analyzing IP address information from the server 3 on the Internet, an access destination notification section 10 for issuing a notification of access destination information to the authorized user, and an authorized user information storage section 11 for storing registration information of the authorized user. The server 3 on the Internet includes an IP address information providing server 27 for providing IP address information in response to a request from the home server 1.

Operation of the home server access system having the configuration described above is described below.

First, the IP address information request issuance section 14 in the home server 1 receives an IP address information request issuing instruction from a user and sends an IP address information request to the IP address information providing server 27 on the Internet. The IP address information providing server 27 receives the IP address information request and acquires a global IP address of the home server 1 and then sends back the global IP address as IP address information to the home server 1.

For example, the IP address information providing server 27 is provided with a script process of acquiring an IP address of a host computer from which the IP address information providing server 27 is accessed and homepage contents for displaying the acquired IP address on a homepage. Where the IP address information providing server 27 has such script process and homepage contents as just described, if the home server 1 accesses the homepage of the IP address information providing server 27, then it can acquire an HTML document including the IP address of the home server 1 itself as IP address information.

The IP address information analysis section 13 of the home server 1 performs a text analysis of the IP address information, that is, the HTML document to extract a portion of the HTML document which includes a predetermined tag, character string or the like and further extracts such an IP address form as “*.*.*.*” (* is a numeral ranging from 0 to 255) and outputs the extracted information to the access destination notification section 10. The access destination notification section 10 receives the IP address information from the IP address information analysis section 13 and transmits access destination information to the terminal 2 of the authorized user.

The access destination information is an IP address or information of the URL form which includes directory information in the home server added to the IP address such as, for example, http: //*.*.*.*/, http://*.*.*.*/home/ or the like (* represents a numeral ranging from 0 to 255). Further, as measures for transmitting access destination information, for example, an electronic mail is used. Further, destination information of the authorized user such as, for example, a mail address is set in advance to the access destination notification section 10 by the user similarly as in the home server access system of FIG. 1.

It is to be noted that the authorized user having acquired the access destination information now accesses the home server 1 in a similar manner as in the home server access system of FIG. 1 described hereinabove.

While the IP address information providing server 27 embeds an IP address in its homepage documents and provides it to the home server 1 in such a manner as described above, the IP address information providing server 27 may otherwise return a value of an IP address to the home server 1 by a communication process of the HTTP protocol or else by an electronic mail.

In this manner, according to the server and the home server access system as well as the access control method of the present embodiment, the IP address information request issuance section 14 can receive an IP address information request issuing instruction from the user and send an IP address information request to the IP address information providing server 27 on the Internet, and the IP address information providing server 27 can acquire the IP address of the home server 1 and sends IP address information to the home server 1. Further, the IP address information analysis section 13 of the home server 1 can receive and analyze the IP address to acquire of the IP address of the home server 1 itself. Then, the access destination notification section 10 can receive the IP address outputted from the IP address information analysis section 13 and transmit access destination information to the terminal 2. Consequently, the authorized user can acquire the access destination information and access the home server 1 using a common HTTP request.

Accordingly, similarly as in the home server access system, even if the home server 1 cannot utilize a fixed global IP address or a dynamic DNS service, a user who has been authorized to access in advance can access the home server 1. Further, also where it is desired to avoid accessing or attack from many and unspecified persons in the world, since a notification of accessing destination information can be issued only to a user to whom accessing is permitted, the present invention is effective also in respect of the security.

Further, in the server and home server access system as well as access control method of the present second embodiment, since a global IP address of the home server 1 can be acquired from the IP address information providing server 27 on the Internet, also where the home server 1 is connected to the Internet through a router, a connection to the home server 1 can be established from another host computer connected to the Internet. Further, also where the global IP address of the router is not fixed as frequently seen in ADSL connections, a connection to the home server 1 can be established from an external host computer.

[First Modifications]

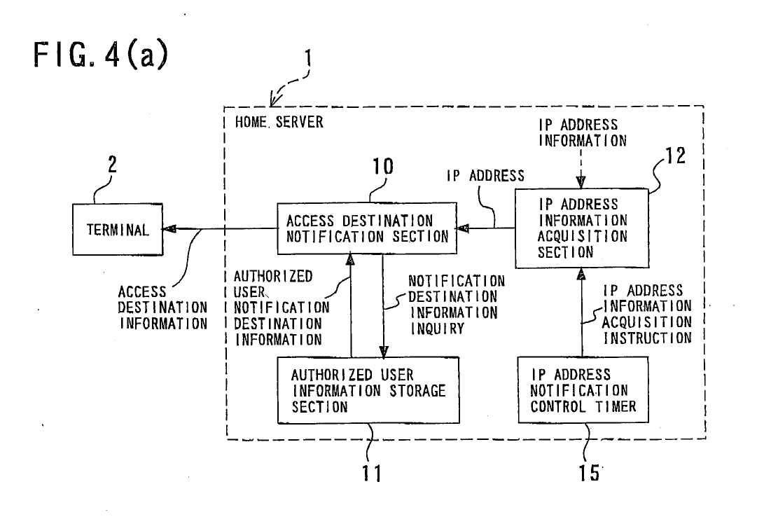

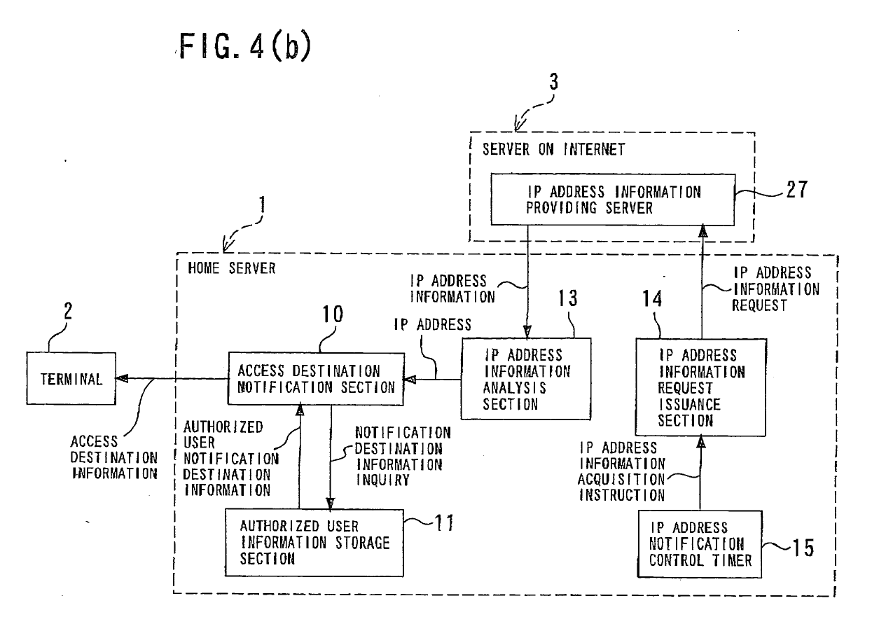

FIGS. 4(a) and4(b) show modifications to the home server access systems of FIGS. 1 and 3 described above.

In the home server access systems of the first and second embodiments described above, an IP address is acquired in response to an IP address information acquiring instruction or an IP address information request issuing instruction from a user However, the home server access systems of the first and second embodiment may be modified in such a manner as seen in FIGS. 4(a) and 4(b), respectively. In particular, the modified home server access systems additionally include an IP address notification control timer 15 for outputting an IP address information acquiring instruction used in the first embodiment or an IP address information request issuing instruction used in the second embodiment so that the IP address is acquired periodically in response to the IP address notification control timer 15.

Since the modified home server access systems additionally include the IP address notification control timer 15 in this manner, operation of the IP address notification control timer 15 is described below.

The IP address notification control timer 15 outputs an IP address information acquiring instruction or an IP address information request issuing instruction at predetermined times of day or at predetermined intervals of time. In order to acquire predetermined times of day or predetermined intervals of time, a method of supervising the system clock in the home server 1 to detect that each predetermined time of day comes, another method of setting a value corresponding to a predetermined interval of time to a system timer in the home server 1 so that a timer interruption signal may be produced by the system timer, and so forth are available.

Operation of the IP address information acquisition section 12 or the IP address information request issuance section 14 and so forth is similar to that in the home server access systems of the first and second embodiments described above with reference to FIGS. 1 and 3.

In this manner, with the server and home server access system as well as access control method of the first modifications, the IP address notification control timer 15 can output an IP address information acquiring instruction or an IP address information request issuing instruction at predetermined times of day or at predetermined intervals of time. Consequently, necessary processes from acquisition of an IP address to notification of access destination information to the authorized user can be performed automatically. Accordingly, although, in such an Internet connection that a global IP address provided is sometimes changed dynamically, usually it is not known to a user when the IP address is changed, where the IP address of the home server 1 can be investigated and acquired periodically and conveyed to the authorized user as in the present modifications, an advantage that the problem that a server cannot be found out upon accessing is eliminated is achieved.

[Second Modifications]

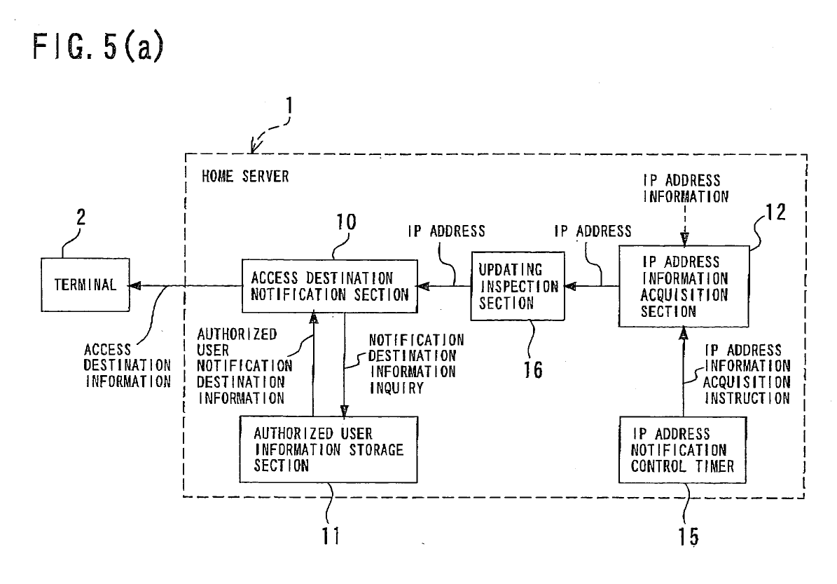

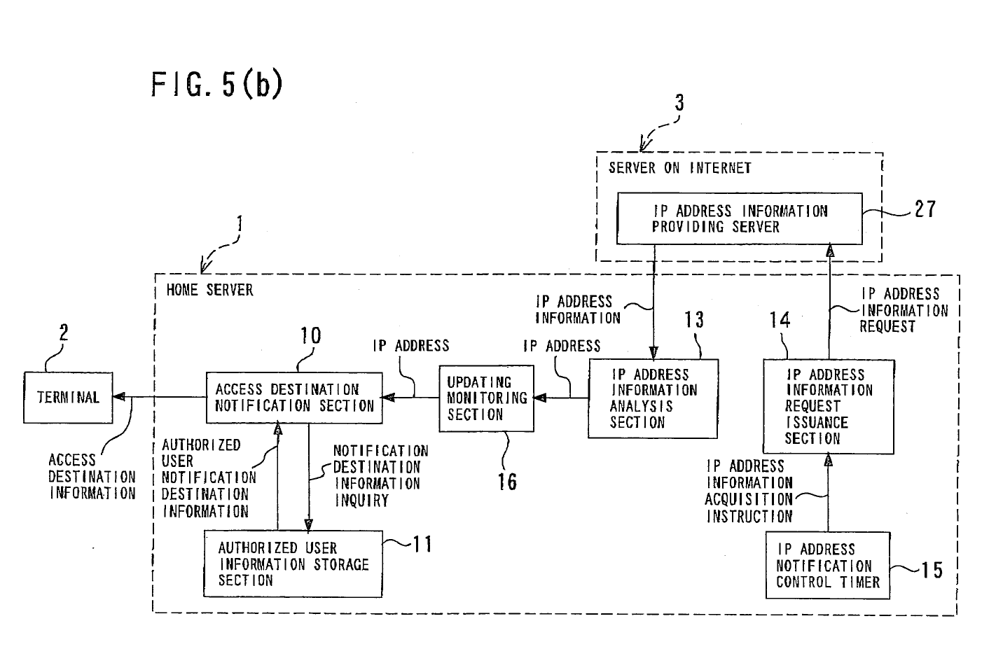

FIGS. 5(a) and 5(b) show different modifications to the server and home server access system as well as access control method of the first and embodiments described above, respectively. The modifications of FIGS. 5(a) and 5(b) are also modifications to but are different from the modifications described above with reference to FIGS. 4(a) and 4(b) in that they additionally include an updating monitoring section 16 for examining updating of an IP address.

Therefore, operation relating to the updating monitoring section 16 is described below.

After an IP address is acquired in a similar manner as in the first modifications, the updating monitoring section 16 examines whether or not the IP address acquired exhibits a change from that acquired last. To this end, the updating monitoring section 16 stores the IP address acquired last therein and compares the last acquired IP address and the newly acquired IP address with each other. Then, only when the two IP addresses are different from each other, the updating monitoring section 16 outputs the new IP address to the access destination notification section 10 so that a notification of it may be issued to the authorized user from the access destination notification section 10.

In this manner, since each of the present modifications additionally includes the updating monitoring section 16, a change of the IP address can be detected, and only when the IP address has been updated, a notification of the IP address can be issued to the authorized user. Consequently, the present modifications can cope with a case wherein the authorized user wants to receive a notification only when the IP address has been changed.

[Third Modifications]

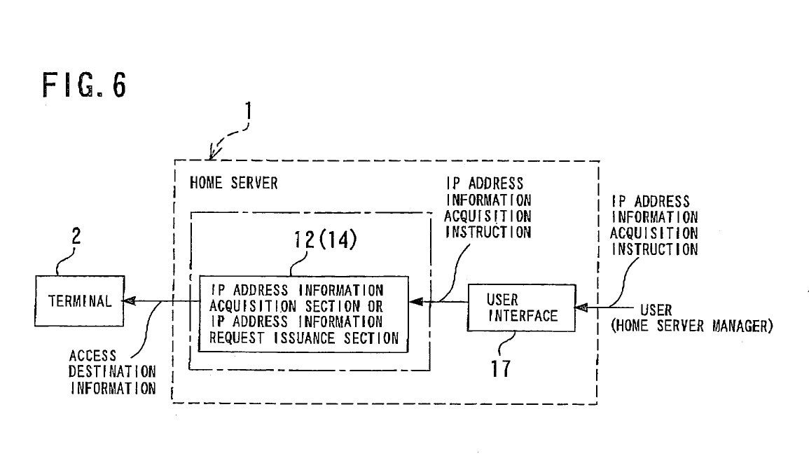

FIG. 6 shows a configuration of a modification to the modifications described above with reference to FIGS. 4(a) and 4(b) together with a procedure of outputting access destination information.

Referring to FIG. 6, the modified home server access system is different from the first modified home server access system only in that a user interface 17 for being operated by a user to issue an IP address information acquisition instruction is added to the IP address information acquisition section 12 or the IP address information request issuance section 14 of the first modified home server access system so that IP address information can be acquired in accordance with the will of the user.

Thus, operation relating to the user interface 17 is described below.

The user interface 17 provides a user interface for acquiring an IP address in order that a user of the home server such as a home server administrator may input an instruction. Where the OS of the home server 1 typically is the “Windows”, the user interface is provided in such a form that it includes an IP address acquisition instruction program and an “IP address acquisition” button is provided in a window of the program such that the user may click the button.

In this manner, since the present modified home server access system includes the user interface 17 in addition to the configuration of the modified home server access system described above with reference to FIG. 4(a) or 4(b), an IP address can be acquired when the user of the home server 1 wants it. Consequently, when the user of the home server 1 wants to acquire an IP address and notify the authorized user of the IP address within an interval between periodical acquisitions of the IP address.

[Fourth Modification]

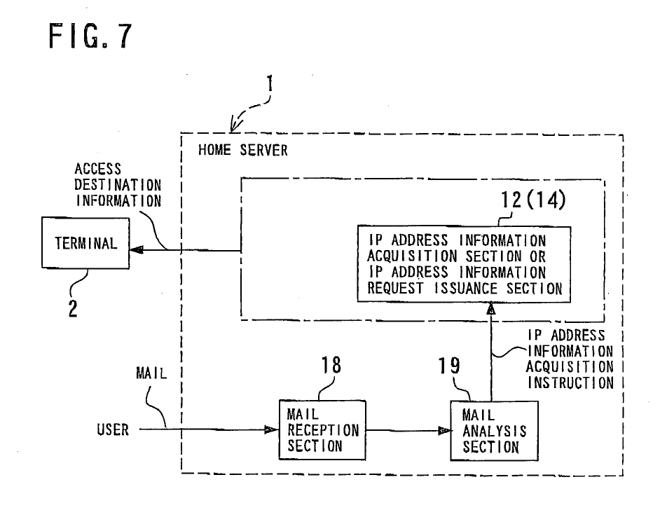

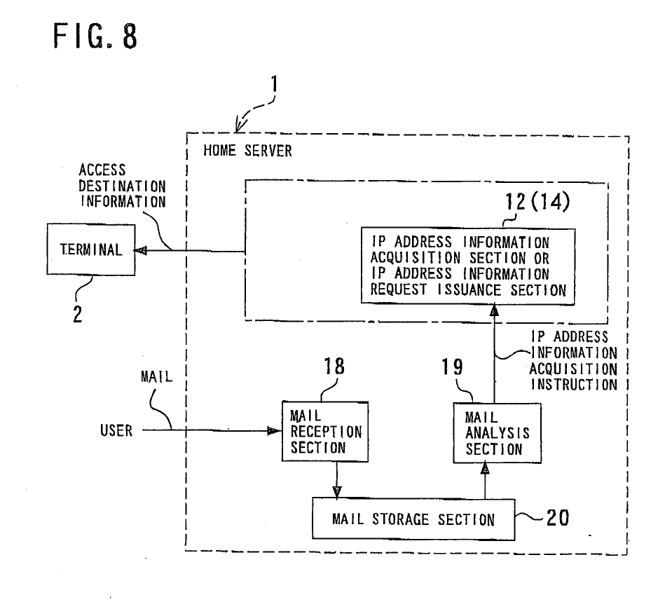

FIG. 7 shows a configuration of another modification to the modifications described above with reference to FIGS. 4(a) and 4(b) together with a procedure of outputting access destination information.

Referring to FIG. 7, the present modified home server access system is different from the first modified home server access systems of FIGS. 4(a) and 4(b) only in that a mail reception section 18 and a mail analysis section 19 are added to the IP address information acquisition section 12 or the IP address information request issuance section 14 of the first modified home server access system so that a request for acquisition of an IP address can be issued readily.

Thus, operation relating to the mail reception section 18 and the mail analysis section 19 is described below.

The mail reception section 18 receives a mail from a user and passes it to the mail analysis section 19. The mail reception section 18 can be implemented, for example, by installing software for receiving an electronic mail from a mail spool of an Internet service provider using a protocol such as the POP3 protocol or the IMAP protocol such as “fetchmail” or “sendmail”. The received electronic mail is passed to the mail analysis section 19. The mail analysis section 19 performs an analysis of the case name and the originating person of the mail from the user and an analysis of the text of the mail. If the originating person is the authorized user and a predetermined description which signifies a request for access destination information notification from the case name or the text is extracted, then the mail analysis section 19 outputs an IP address information acquisition instruction or an IP address request issuance instruction. Later processing of the present modified home server access system is similar to that in the first modified home server access system. Thus, a notification of access destination information is issued to the authorized user.

In this manner, in the present modified home server access system, since it includes the mail reception section 18 in addition to the configuration of the first modified home server access system, an electronic mail from a user can be received, and since the mail analysis section 19 is provided additionally, it can discriminate whether or not the received electronic mail signifies a request for access destination information notification and output an IP address information acquisition instruction or an IP address information request issuance instruction. Thereafter, such processes up to notification of access destination information as in those of the first modified home server access system can be performed. Consequently, when the authorized user wants to acquire access destination information using an electronic mail from the user in addition to periodical access destination information notifications, a notification of access destination information can be issued.

The modified home server access system of FIG. 7 may be further modified such that the home server 1 additionally includes a mail storage section 20 for storing a received electronic mail once and the mail analysis section 19 suitably reads out and utilizes the electronic mail stored in the mail storage section 20.

[Fifth Modification]

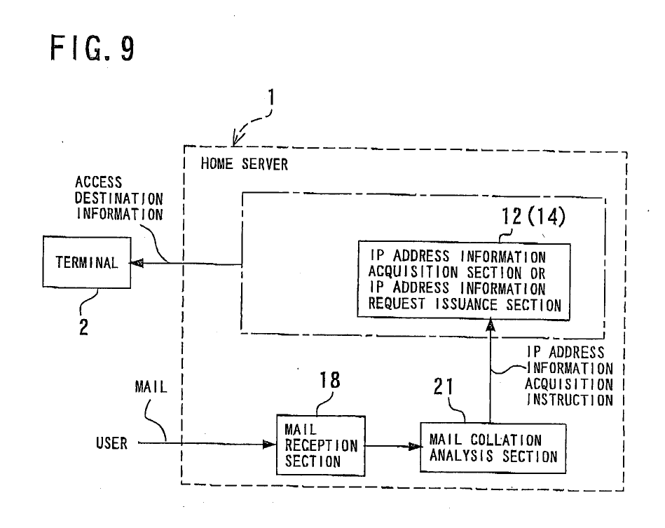

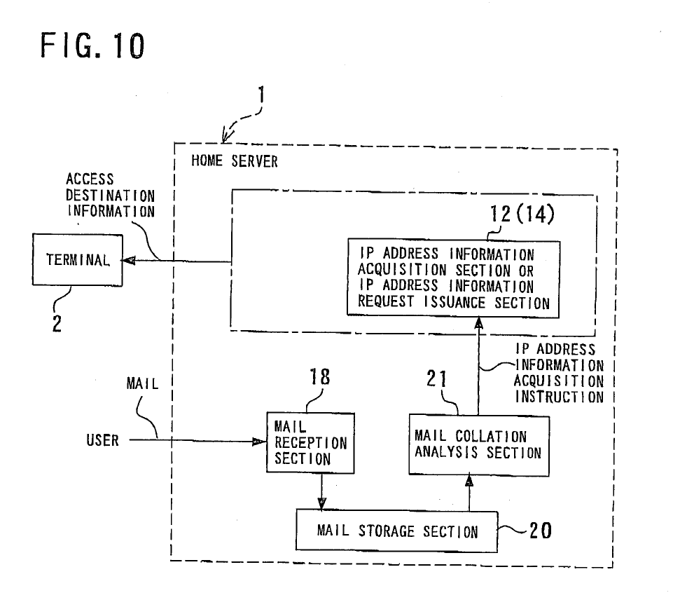

FIG. 9 shows a configuration of another modification to the third modified home server access system of FIG. 7 together with a procedure of outputting access destination information.

Referring to FIG. 9, the present modified home server access system is different from the modified home server access system of FIG. 7 only in that it includes a mail collation analysis section 21 in place of the mail analysis section 19 so that the security of the system is promoted.

Thus, operation relating to the mail collation analysis section 21 is described below.

In the home server 1 of FIG. 9, when a mail originating person prepares an electronic mail for a request for access destination information from the user, information for authenticating the authorized user is included in the case name, text or some other part of the electronic mail.

After the electronic mail from the user is received by the mail reception section 18 and passed to the mail collation analysis section 21, the mail collation analysis section 21 performs, for example, a text analysis of the mail to check whether or not information, for authenticating the authorized user is included in the case name, text or the like of the mail. If such information is detected, then the mail collation analysis section 21 issues an IP address information acquisition instruction or an IP address request issuance instruction. However, if such information is not detected, then the mail collation analysis section 21 outputs nothing. Processing of the home server 1 after an IP address information acquisition instruction or an IP address request issuance instruction is outputted is similar to that in the third modified home server access system of FIG. 7.

In this manner, in the modified home server access system of FIG. 9, since the home server 1 includes the mail collation analysis section 21 in place of the mail analysis section 19 of the home server 1 of FIG. 7, it can be discriminated whether or not an electronic mail which includes a request for access destination information has been originated from the authorized user, and only when such a request from the authorized user is detected, access destination information can be transmitted. Consequently, accessing to the home server 1 from any other than the authorized user can be prevented, and the security of the system is promoted.

Also the modified home server access system of FIG. 9 may be further modified such that the home server 1 additionally includes a mail storage section 20 and the mail analysis collation section 21 suitably reads out and utilizes the electronic mail stored in the mail storage section 20.

[Sixth Modification]

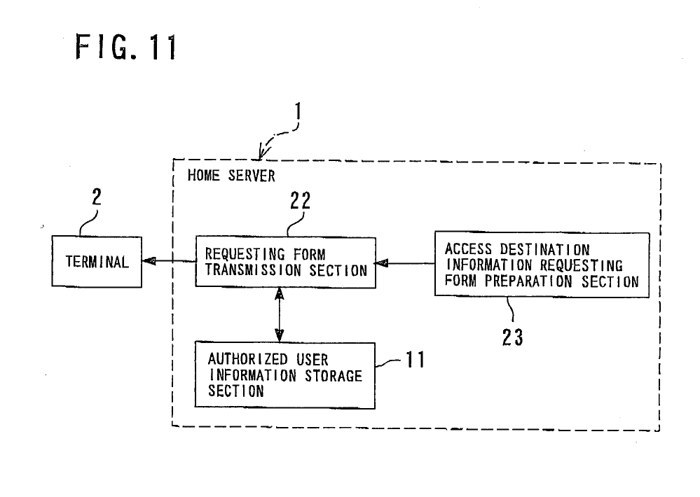

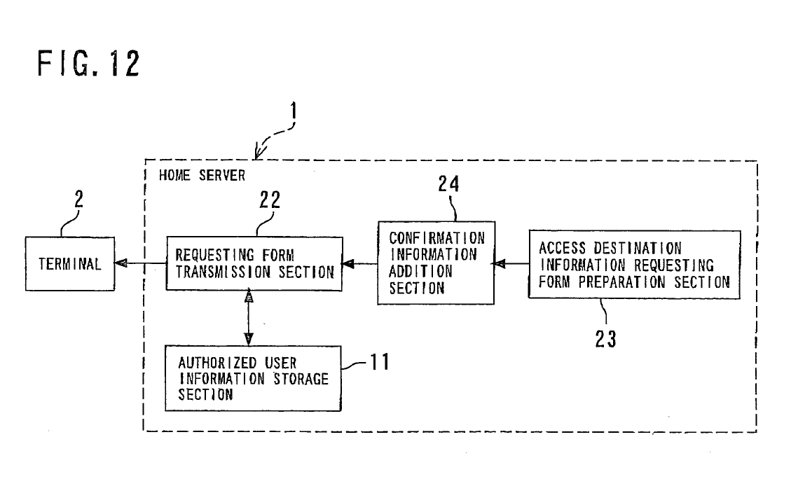

FIG. 11 shows a configuration of a modification to the fourth or fifth modified home server access system of FIG. 7 or 9 together with a procedure of outputting access destination information.

Referring to FIG. 11, the modified home server access system is different from the modified home server access system of FIG. 7 or 9 only in that it includes an access destination information requesting form preparation section 23 and a requesting form transmission section 22 in addition to the components of the modified home server access system of FIG. 7 or 9 so that the security of the system is promoted and the burden when the authorized user issues a request for access destination information is reduced.

Thus, operation relating to the access destination information requesting form preparation section 23 and the requesting form transmission section 22 is described below.

The access destination information requesting form preparation section 23 prepares an electronic mail and passes it to the requesting form transmission section 22. The requesting form transmission section 22 reads out the mail address of the authorized user from the authorized user information storage section 11 to determine a transmission destination of the prepared electronic mail and transmits the electronic mail to the transmission destination.

If the authorized user having received the requesting form as an electronic mail sends an electronic mail of a reply, then the mail analysis section 19 or the mail collation analysis section 21 discriminates whether or not the electronic mail received is a reply to the requesting form. If it is discriminated that the received electronic mail is a reply, then the mail analysis section 19 or the mail collation analysis section 21 outputs an IP address information acquisition instruction or an IP address request issuance instruction, but if it is discriminated that the received electronic mail is not a reply, then the mail analysis section 19 or the mail collation analysis section 21 outputs nothing. Processing of the home server 1 after an IP address information acquisition instruction or an IP address request issuance instruction is outputted is similar to that in the fourth or fifth modified home server access system of FIG. 7 or 9.

In this manner, in the modified home server access system of FIG. 11, since the home server 1 in the modified home server access system of FIG. 7 or 9 additionally includes the access destination information requesting form preparation section 23, a mail of a predetermined case name or text can be prepared. Further, since the home server 1 additionally includes the requesting form transmission section 22, it is possible to read out the mail address of the authorized user from the authorized user information storage section 11 to determine a transmission destination of the prepared mail and transmit the mail to the transmission destination.

Consequently, the authorized user can acquire access destination information by sending a reply. Further, since a requesting form is sent only to the authorized user and access destination information is conveyed only in response to a reply from the authorized user, accessing to the home server 1 from any other than the authorized user can be prevented, and the security of the system can be promoted. Further, the burden when the authorized user issues a request for access destination information can be reduced.

The modified home server access system of FIG. 11 may be further modified such that it additionally includes a confirmation information addition section 24 interposed between the access destination information requesting form preparation section 23 and the requesting form transmission section 22 so that the requesting form may be transmitted after confirmation information of a predetermined case name, text or the like is included into the requesting form. This gives rise to an advantage that it makes it easy for the home server 1 to discriminate a mail which signifies a request for access destination information notification from the authorized user.

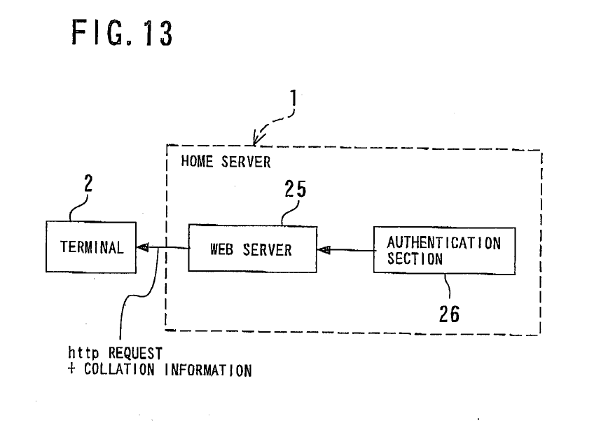

The home server access systems of the embodiments and the modifications described hereinabove may be modified such that authentication information is added to access destination information included in a notification to the authorized user and authentication is performed by an authentication section 26 when the authorized user actually performs accessing to a web server 25 as seen in FIG. 13. Further, if such authentication information is determined, for example, using a random number, then this makes it possible to prevent illegal accessing and the security can be promoted.

While preferred embodiments of the present invention have been described using specific terms, such description is for illustrative purposes only, and it is to be understood that changes and variations may be made without departing from the spirit or scope of the following claims.

What is claimed is:

1. A server, comprising:
address information acquisition means for acquiring an address of the server itself on a network;
authorized user information storage means for storing information which specifies a contact address of a user authorized to access said server in advance; and
access destination notification means for issuing a notification of access destination information produced based on the address acquired by said address information acquisition means to the contact address of the authorized user.

2. A server as claimed in claim 1, further comprising address notification control means for signaling an address information acquiring instruction to said address information acquisition means or an address information request issuing instruction to said address information request issuance means at time determined in advance or at intervals of time determined in advance, and wherein the address is automatically acquired by said address notification control means and a notification of the address is issued to the contact address of the authorized user.

3. A server as claimed in claim 2, further comprising update monitoring means for storing the address and comparing the stored address and a newly acquired address with each other, and wherein, only when it is discriminated by said update monitoring means that the address is updated, a notification of the address is issued to the contact address of the authorized user.

4. A server as claimed in claim 1, further comprising instruction means operable by a home server administrator and the authorized user for signaling an address information acquiring instruction to said address information acquisition means or an address information request issuing instruction to said address information request issuance means, and wherein, if the administrator or user issues an instruction using said instruction means, then the address is acquired.

5. A server as claimed in claim 1, further comprising mail reception means for receiving an address acquisition instruction mail through the network and mail analysis means for analyzing the received address acquisition instruction mail, and wherein the address information acquiring instruction or the address information request issuing instruction information is searched from within the address acquisition instruction mail, and if the information is included, then the address is acquired.

6. A server as claimed in claim 5, wherein said mail analysis means includes a function for searching authentication information of the authorized user from within the address acquisition instruction mail, and, if the authentication information is included, then the searching for the address information acquiring instruction or the address information request issuing instruction information is executed.

7. A server as claimed in claim 5, further comprising means for producing a request form for the address acquisition instruction mail and means for transmitting the request form to a terminal of the authorized user, and wherein, if the address acquisition instruction mail is received as a reply from the terminal of the authorized user, then acquisition of the address is executed.

8. A server as claimed in claim 1, wherein the access destination information is the address or information of the URL format produced by adding directory information in the server to the address.

9. A server as claimed in claim 1, wherein, when the authorized user accesses the server, user authentication is performed.

10. A server as claimed in claim 1, wherein authentication information is added to the access destination information, and, when the authorized user accesses the server, user authentication is performed.

11. A server, comprising:
address information request issuance means for issuing an address information request to an address information providing server on the Internet;
address information analysis means for analyzing the address information received from the address information providing server to acquire an address of the server itself;
authorized user information storage means for storing information which specifies a contact address of a user authorized to access said server in advance; and
access destination notification means for issuing a notification of access destination information produced based on the address acquired by said address information analysis means to the contact address of the authorized user.

12. A server as claimed in claim 11, further comprising address notification control means for signaling an address information acquiring instruction to said address information acquisition means or an address information request issuing instruction to said address information request issuance means at time determined in advance or at intervals of time determined in advance, and wherein the address is automatically acquired by said address notification control means and a notification of the address is issued to the contact address of the authorized user.

13. A server as claimed in claim 12, further comprising update monitoring means for storing the address and comparing the stored address and a newly acquired address with each other, and wherein, only when it is discriminated by said update monitoring means that the address is updated, a notification of the address is issued to the contact address of the authorized user.

14. A server as claimed in claim 11, further comprising instruction means operable by a home server administrator and the authorized user for signaling an address information acquiring instruction to said address information acquisition means or an address information request issuing instruction to said address information request issuance means, and wherein, if the administrator or user issues an instruction using said instruction means, then the address is acquired.

15. A server as claimed in claim 11, further comprising mail reception means for receiving an address acquisition instruction mail through the network and mail analysis means for analyzing the received address acquisition instruction mail, and wherein the address information acquiring instruction or the address information request issuing instruction information is searched from within the address acquisition instruction mail, and if the information is included, then the address is acquired.

16. A server as claimed in claim 15, wherein said mail analysis means includes a function for searching authentication information of the authorized user from within the address acquisition instruction mail, and, if the authentication information is included, then the searching for the address information acquiring instruction or the address information request issuing instruction information is executed.

17. A server as claimed in claim 15, further comprising means for producing a request form for the address acquisition instruction mail and means for transmitting the request form to a terminal of the authorized user, and wherein, if the address acquisition instruction mail is received as a reply from the terminal of the authorized user, then acquisition of the address is executed.

18. A server as claimed in claim 11, wherein the access destination information is the address or information of the URL format produced by adding directory information in the server to the address.

19. A server as claimed in claim 11, wherein, when the authorized user accesses the server, user authentication is performed.

20. A server as claimed in claim 11, wherein authentication information is added to the access destination information, and, when the authorized user accesses the server, user authentication is performed.

21. A home server access system, comprising:
a home server; and
a plurality of terminals of different users connected to said home server through a network;
said home server including address information acquisition means for acquiring an address of the server itself on the network, authorized user information storage means for storing information which specifies a contact address of a user authorized to access said home server in advance, and access destination notification means for issuing a notification of access destination information produced based on the address acquired by said address information acquisition means to the contact address of the authorized user.

22. A home server access system, comprising:
a home server; and
a plurality of terminals of different users connected to said home server through a network;
said home server including address information request issuance means for issuing an address information request to an address information providing server on the Internet, address information analysis means for analyzing the address information received from the address information providing server to acquire an address, authorized user information storage means for storing information which specifies a contact address of a user authorized to access said home server in advance, and access destination notification means for issuing a notification of access destination information produced based on the address acquired by said address information analysis means to the contact address of the authorized user.

23. An access control method executed by a server, comprising the steps of:
acquiring an address of said server itself on a network;
storing information which specifies a contact address of a user authorized to access said server in advance; and
issuing a notification of access destination information produced based on the acquired address to the contact address of the authorized user.

24. An access control method as claimed in claim 23, wherein the step of acquiring the address is automatically executed at time determined in advance or at intervals of time determined in advance by a timer provided in the server.

25. An access control method as claimed in claim 24, wherein, after the step of acquiring the address is executed, a step of comparing the previously acquired address and a newly acquired address with each other is executed, and, only when it is discriminated by the comparison step that the address is updated, a notification of the newly acquired address is issued to the contact address of the authorized user.

26. An access control method as claimed in claim 23, wherein, if a user issues an instruction using instruction means which can transmit an address information acquisition instruction at the address acquisition step or an address information request issuance instruction at the address information request issuance step, then the address is acquired.

27. An access control method as claimed in claim 23, wherein a step of receiving an address acquisition instruction mail transmitted through the network, a step of analyzing the received address acquisition instruction mail and a step of searching an address information acquisition instruction at the address acquisition step or an address information request issuance instruction at the address information request issuance step from within the address acquisition instruction mail are executed, and if the instruction is included, then the address is acquired.

28. An access control method as claimed in claim 27, wherein, at the mail analysis step, authentication information of the authorized user is searched from within the address acquisition instruction mail, and if the authentication information is included, then the searching for the address information acquiring instruction or the address information request issuing instruction is executed.

29. An access control method as claimed in claim 27, further comprising the steps of:
producing a request form of the address acquisition instruction mail; and
transmitting the request form to the contact address of the authorized user; and wherein,
if the address acquisition instruction mail is received as a reply from a terminal of the authorized user, then the acquisition of the address is executed.

30. An access control method as claimed in claim 23, wherein the access destination information is the address or information of the URL format produced by adding directory information in the server to the address.

31. An access control method as claimed in claim 23, wherein authentication information is added to the access destination information, and, when the authorized user accesses the server, user authentication is performed.

32. An access control method as claimed in claim 31, wherein authentication information which can designate whether or not each of folders or files can be accessed is used as the authentication information.

33. An access control method executed by a server, comprising the steps of:
issuing an address information request to an address information providing server on the Internet;
analyzing the address information received from the address information providing server to acquire an address;
storing information which specifies a contact address of a user authorized to access said server in advance; and
issuing a notification of access destination information produced based on the acquired address to the contact address of the authorized user.

34. An access control method as claimed in claim 33, wherein the step of acquiring the address is automatically executed at time determined in advance or at intervals of time determined in advance by a timer provided in the server.

35. An access control method as claimed in claim 34, wherein, after the step of acquiring the address is executed, a step of comparing the previously acquired address and a newly acquired address with each other is executed, and, only when it is discriminated by the comparison step that the address is updated, a notification of the newly acquired address is issued to the contact address of the authorized user.

36. An access control method as claimed in claim 33, wherein, if a user issues an instruction using instruction means which can transmit an address information acquisition instruction at the address acquisition step or an address information request issuance instruction at the address information request issuance step, then the address is acquired.

37. An access control method as claimed in claim 33, wherein a step of receiving an address acquisition instruction mail transmitted through the network, a step of analyzing the received address acquisition instruction mail and a step of searching an address information acquisition instruction at the address acquisition step or an address information request issuance instruction at the address information request issuance step from within the address acquisition instruction mail are executed, and if the instruction is included, then the address is acquired.

38. An access control method as claimed in claim 37, wherein, at the mail analysis step, authentication information of the authorized user is searched from within the address acquisition instruction mail, and if the authentication information is included, then the searching for the address information acquiring instruction or the address information request issuing instruction is executed.

39. An access control method as claimed in claim 37, further comprising the steps of:
producing a request form of the address acquisition instruction mail; and
transmitting the request form to the contact address of the authorized user; and wherein,
if the address acquisition instruction mail is received as a reply from a terminal of the authorized user, then the acquisition of the address is executed.

40. An access control method as claimed in claim 33, wherein the access destination information is the address or information of the URL format produced by adding directory information in the server to the address.

41. An access control method as claimed in claim 33, wherein authentication information is added to the access destination information, and, when the authorized user accesses the server, user authentication is performed.

42. An access control method as claimed in claim 41, wherein authentication information which can designate whether or not each of folders or files can be accessed is used as the authentication information.
